(19) United States
(12) Patent Application Publication
(10) Pub. No.: US 2026/0252213 A1
(43) Pub. Date: Aug. 27, 2026

(54) INFORMATION DISPLAY METHOD, APPARATUS, READABLE MEDIUM, ELECTRONIC DEVICE, AND PROGRAM PRODUCT

(71) Applicant: Beijing Youzhuju Network Technology Co., Ltd., Beijing (CN)

(72) Inventors: Zhongrui CAO, Beijing (CN); Xiaoqian CHEN, Beijing (CN); Ziyi CHEN, Beijing (CN); Changxin CHEN, Beijing (CN); Xin CHEN, Beijing (CN); Shijia XU, Beijing (CN); Yanchi LI, Beijing (CN); Kun DU, Beijing (CN); Youjun ZHANG, Beijing (CN); Mengna BAI, Beijing (CN); Duoli XU, Beijing (CN); Zhijun GOU, Beijing (CN); Yihui XIE, Beijing (CN); Ke YAO, Beijing (CN); Chunqing SUN, Beijing (CN); Xin MENG, Beijing (CN); Danyi CHEN, Beijing (CN); Lang GONG, Beijing (CN)

(21) Appl. No.: 19/448,096

(22) Filed: Jan. 13, 2026

(30) Foreign Application Priority Data
Feb. 25, 2025 (CN) 202510214514.5

(51) Int. Cl. G06F 3/0483; G06F 3/0482; G06F 3/0484

(52) U.S. Cl. CPC G06F 3/0483; G06F 3/0482; G06F 3/0484

(57) ABSTRACT

An information display method, an apparatus, a readable medium, an electronic device and a program product. The method includes: displaying an object management page for managing a target object; and in response to a trigger operation on association information of the target object in the object management page, displaying target association information (including first association information and/or second association information) used for representing an association cognition of a user to the target object, where the first association information is used for representing association cognition information of the user to a category to which the target object belongs and the target object, and the second association information is used for representing association cognition information of the user to an attribute word of the target object and the target object.

### CROSS-REFERENCE TO RELATED APPLICATION(S)

The present application claims priority to Chinese Patent Application No. 202510214514.5, filed with the China National Intellectual Property Administration on Feb. 25, 2025, and entitled “INFORMATION DISPLAY METHOD, APPARATUS, READABLE MEDIUM, ELECTRONIC DEVICE, AND PROGRAM PRODUCT”, which is incorporated herein by reference in its entirety.

### FIELD

The present disclosure relates to the field of computer technology, and in particular, to an information display method, an apparatus, a readable medium, an electronic device, and a program product.

### BACKGROUND

In the field of e-commerce, it is usually necessary to perform statistical analysis on data and information of various objects (such as brands, products, live rooms, and so on). For example, a brand party usually needs to regularly perform statistical analysis on market performance data and user feedback data of a brand, so as to gain insight into consumers' cognitive information about the brand.

However, in the related art, there are problems such as complex statistical analysis operations and low statistical analysis efficiency.

### SUMMARY

The Summary section is provided in order to introduce concepts in a brief form, and these concepts will be described in detail in the following Detailed Description section. The contents described in this Summary section are not intended to identify key or necessary features of the embodiments of the present disclosure, nor is it intended to limit the scope of the present disclosure.

In a first aspect, the present disclosure provides an information display method, including:
displaying an object management page for managing a target object; and
in response to a trigger operation on association information of the target object in the object management page, displaying target association information of the target object, where the target association information is used for representing an association cognition of a user to the target object, the target association information includes first association information and/or second association information, the first association information is used for representing association cognition information of the user to a category to which the target object belongs and the target object, and the second association information is used for representing association cognition information of the user to an attribute word of the target object and the target object.

In a second aspect, the present disclosure provides an information display apparatus, including:
a first display module, configured to display an object management page for managing a target object; and
a second display module, configured to, in response to a trigger operation on association information of the target object in the object management page, display target association information of the target object, where the target association information is used for representing an association cognition of a user to the target object, the target association information includes first association information and/or second association information, the first association information is used for representing association cognition information of the user to a category to which the target object belongs and the target object, and the second association information is used for representing association cognition information of the user to an attribute word of the target object and the target object.

In a third aspect, the present disclosure provides a computer readable medium having a computer program stored thereon, where when the computer program is executed by a processing apparatus, the steps of the method according to the first aspect are implemented.

In a fourth aspect, the present disclosure provides an electronic device, including:
a storage apparatus having a computer program stored thereon; and
a processing apparatus, configured to execute the computer program in the storage apparatus to implement the steps of the method according to the first aspect.

In a fifth aspect, the present disclosure provides a computer program product including a computer program, where when the computer program is executed by a processor, the steps of the method according to the first aspect are implemented.

Other features and advantages of the present disclosure will be described in detail in the following Detailed Description section.

### BRIEF DESCRIPTION OF THE DRAWINGS

The above and other features, advantages and aspects of various embodiments of the present disclosure will become more apparent when taken in conjunction with the drawings and with reference to the following detailed description. Throughout the drawings, the same or similar reference numerals represent the same or similar elements. It should be understood that the drawings are schematic, and the components and elements are not necessarily drawn to scale. In the drawings:

FIG. 1 is a flowchart of an information display method according to an exemplary embodiment of the present disclosure;

FIG. 2 is a schematic diagram of displaying first association information according to an exemplary embodiment of the present disclosure;

FIG. 3 is a schematic diagram of displaying second association information according to an exemplary embodiment of the present disclosure;

FIG. 4 is another schematic diagram of displaying second association information according to an exemplary embodiment of the present disclosure;

FIG. 5 is a schematic diagram of displaying a change trend and ranking information according to an exemplary embodiment of the present disclosure;

FIG. 6 is a schematic diagram of displaying association cognition details according to an exemplary embodiment of the present disclosure;

FIG. 7 is a schematic diagram of displaying comparison information among different objects according to an exemplary embodiment of the present disclosure;

FIG. 8 is a schematic diagram of displaying a multimedia content list according to an exemplary embodiment of the present disclosure;

FIG. 9 is a schematic diagram of displaying a change trend of association degree with time according to an exemplary embodiment of the present disclosure;

FIG. 10 is a schematic diagram of displaying ranking information of a target object under a fourth indicator according to an exemplary embodiment of the present disclosure;

FIG. 11 is a schematic diagram of displaying multimedia content corresponding to target indicator information according to an exemplary embodiment of the present disclosure;

FIG. 12 is a schematic diagram of displaying first attribute word information according to an exemplary embodiment of the present disclosure;

FIG. 13 is a schematic diagram of displaying second attribute word information according to an exemplary embodiment of the present disclosure;

FIG. 14 is a block diagram of an information display apparatus according to an exemplary embodiment of the present disclosure; and

FIG. 15 is a schematic structural diagram of an electronic device according to an exemplary embodiment of the present disclosure.

### DETAILED DESCRIPTION OF EMBODIMENTS

Embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein; on the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that steps described in method implementations of the present disclosure may be performed in different orders and/or in parallel. In addition, additional steps may be included and/or execution of the steps shown may be omitted in the method implementations. The scope of the present disclosure is not limited in this respect.

As used herein, the term “include/comprise” and its variations are open-ended inclusions, that is, “include/comprise but not limited to”. The term “based on” means “at least partially based on”. The term “an embodiment” means “at least one embodiment”; the term “another embodiment” means “at least one other embodiment”; the term “some embodiments” means “at least some embodiments”. Relevant definitions of other terms will be given in the following description.

It should be noted that concepts such as “first” and “second” mentioned in the present disclosure are only used to distinguish different apparatuses, modules or units, and are not used to limit the order or interdependence of functions performed by these apparatuses, modules or units.

It should be noted that modifiers of “one” and “multiple” mentioned in the present disclosure are illustrative rather than restrictive, and those skilled in the art should understand that they should be understood as “one or multiple” unless clearly indicated in the context otherwise.

The names of messages or information exchanged between multiple apparatuses in the implementations of the present disclosure are for illustrative purposes only, and are not intended to limit the scope of these messages or information.

It may be understood that before using the technical solutions disclosed in various embodiments of the present disclosure, the user should be informed of the type, scope of use, use scenarios, etc. of personal information involved in the present disclosure in an appropriate manner and obtain the authorization of the user according to relevant laws and regulations.

For example, in response to receiving an active request from a user, prompt information is sent to the user to clearly prompt the user that the requested operation will require access to and use of the user's personal information. In this way, the user may independently choose whether to provide the personal information to software or hardware, such as an electronic device, an application, a server or a storage medium, that performs the operations of the technical solutions of the present disclosure based on the prompt information.

As an optional but non-limiting implementation, in response to receiving the active request from the user, the prompt information may be sent to the user in a form of pop-up window, for example, and the prompt information may be presented in text in the pop-up window. In addition, the pop-up window may also carry a selection control for the user to select “agree” or “disagree” to provide the personal information to the electronic device.

It may be understood that the above process of notifying and obtaining user authorization is only illustrative, and does not constitute a limitation on the implementations of the present disclosure, and other methods that meet relevant laws and regulations may also be applied to the implementations of the present disclosure.

Meanwhile, it may be understood that the data involved in the technical solution (including but not limited to the data itself, acquisition or use of the data) should comply with requirements of corresponding laws, regulations and related provisions.

As mentioned in the Background section, in the related art, there are problems such as complex statistical analysis operations and low statistical analysis efficiency.

Exemplarily, in the related art, a brand party generally collects user feedback data in a form of questionnaire, and then performs analysis and statistics based on the collected user feedback data to obtain consumers' overall cognition and evaluation of the brand. However, because this method relies on manual operations, including questionnaire design, distribution, recycling, statistical analysis, and other links, it is not only time-consuming and labor-intensive, but also prone to data deviation due to subjective factors, which in turn affects the accuracy and timeliness of statistical results.

In view of this, the present disclosure provides an information display method, an apparatus, a readable medium, an electronic device, and a program product, so as to solve the above technical problems.

The embodiments of the present disclosure will be further explained below in combination with the drawings.

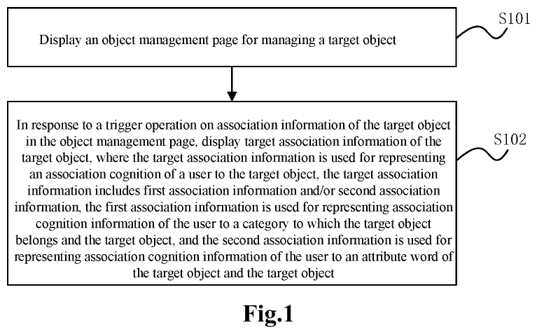

FIG. 1 is a flowchart of an information display method according to an exemplary embodiment of the present disclosure. Referring to FIG. 1, the method may include the following steps:
S101: an object management page for managing a target object is displayed.

In the present embodiment, the target object may be a brand, a product, a live room, or may be other objects, which is not limited in the embodiments of the present disclosure. Correspondingly, the object management page may be a brand management page, a product management page, a live room management page, or other pages.
S102: in response to a trigger operation on association information of the target object in the object management page, target association information of the target object is displayed, where the target association information is used for representing an association cognition of a user to the target object, the target association information includes first association information and/or second association information, the first association information is used for representing association cognition information of the user to a category to which the target object belongs and the target object, and the second association information is used for representing association cognition information of the user to an attribute word of the target object and the target object.

In the present embodiment, the user may be a consumer, and the category to which the target object belongs and the attribute word of the target object may be determined according to the target object, which is not limited in the embodiments of the present disclosure. Exemplarily, when the target object is a brand, the category to which the target object belongs may be an industry to which the brand belongs, such as cosmetics, electronic products, or smart home. The attribute word of the target object may be a mind word of brand mind, where the brand mind is used for representing a cognition and impression formed by a consumer on the brand, and the mind word is a concrete expression of the brand mind, and is key information that the brand expects the consumer to remember, covering personality characteristics, product advantages, brand style and other aspects of the brand. For example, the mind word may include “0 sucrose”, “whitening”, “hydrating”, “luxury”, “affordable”, “silent”, “handmade”, “physical pressing”, or “anti-aging”, and so on. Therefore, the first association information may be used for representing association cognition information of the consumer to the industry to which the brand belongs and the brand, for example, an association degree between the industry to which the brand belongs and the brand, or a fit degree between the industry to which the brand belongs and the brand. The second association information may be used for representing association cognition information of the consumer to the mind word of the brand and the brand, for example, an association degree between the mind word of the brand and the brand, or an association frequency between the mind word of the brand and the brand.

Through the above technical solution, the target association information used for representing the association cognition of the user to the target object may be displayed when the association information of the target object is triggered in the object management page. Therefore, the target association information of the target object may be quickly acquired through a simple interaction operation. In addition, because the target association information may include the information used for representing the association cognition information of the user to the category to which the target object belongs and the target object, and/or the information used for representing the association cognition information of the user to the attribute word of the target object and the target object, the association cognition of the user to the target object may be acquired from different dimensions, thereby improving the comprehensiveness and accuracy of the statistical analysis. For example, when the target object is a brand, through the above technical solution, the cognition information of a consumer to the brand may be quickly acquired through a simple interaction operation. Compared with the related art in which the cognition information of the consumer to the brand is acquired through manual statistics, this method simplifies the operation complexity of acquiring the cognition information and improves the efficiency of acquiring the cognition information. Meanwhile, through multi-dimensional data association analysis, the cognition information of the consumer to the brand may be more comprehensively gained insight into, and the accuracy of the cognition information may be improved.

In order to facilitate understanding of the information display method provided by the present disclosure, possible implementations in the present disclosure will be described below.

In a possible implementation, the first association information may include indicator information corresponding to a first indicator and/or indicator information corresponding to a second indicator, the first indicator is used for representing an association probability of the user to the category to which the target object belongs and the target object, and the second indicator is used for representing an interaction indicator of the user for the target object in the category to which the target object belongs.

In the present embodiment, the indicator information corresponding to the first indicator may include an indicator value corresponding to the first indicator, a reference value corresponding to the first indicator, ranking information of the target object under the first indicator, and the like, and certainly may also include other information, which is not limited in the embodiments of the present disclosure. Correspondingly, the indicator information corresponding to the second indicator may include an indicator value corresponding to the second indicator, a reference value corresponding to the second indicator, ranking information of the target object under the second indicator, and the like, and certainly may also include other information, which is not limited in the embodiments of the present disclosure.

In the present embodiment, the association probability may be a probability that the user associates the target object based on the category to which the target object belongs, or may be a probability that the user associates the category to which the target object belongs based on the target object, or may be a probability that the user associates the target object based on the category to which the target object belongs and a probability that the user associates the category to which the target object belongs based on the target object, and certainly may also be other probabilities, which is not limited in the embodiments of the present disclosure. Exemplarily, when the target object is “XX brand” in a makeup industry, the association probability may include an industry association probability and a product association probability, where the industry association probability is used for representing a probability that a consumer associates the “XX brand” based on the “makeup”, and the product association probability is used for representing a probability that the consumer associates the makeup based on the “XX brand”.

In the present embodiment, the interaction indicator may be a selection probability, a search frequency or a recommendation probability of the user for the target object in the category to which the target object belongs, and certainly may also be other indicators, which is not limited in the embodiments of the present disclosure.

The following uses an example where the “XX brand” in the makeup industry is used as the target object, a mind word of the “XX brand” is used as the attribute word of the target object, and a brand management page is used as the object management page for description.

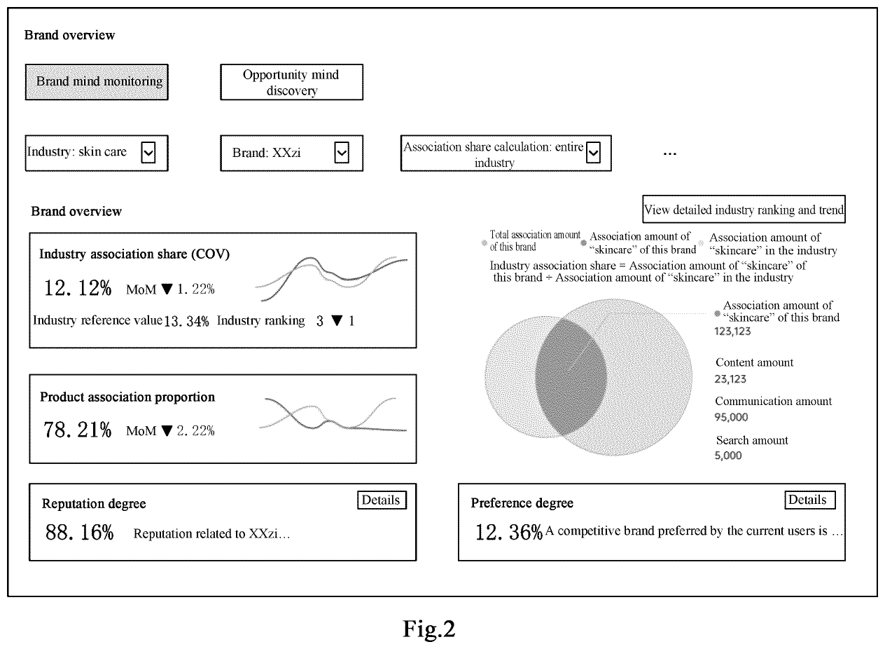

Exemplarily, after a data management platform is opened, a home page of the data management platform may be displayed, and a target function module for managing the “XX brand” may be displayed on the home page of the data management platform. When the target function module is triggered through an operation such as clicking, the brand management page of the “XX brand” may be displayed, and an association information trigger control “brand mind monitoring” may be displayed in the brand management page. When the “brand mind monitoring” is triggered through an operation such as clicking, the first association information of the “XX brand” may be displayed on the brand management page, as shown in FIG. 2. The first association information includes indicator information corresponding to a first indicator and indicator information corresponding to a second indicator, the first indicator includes an industry association probability and a product association probability, the industry association probability is used for representing a probability that a consumer associates the “XX brand” based on “skin care”, and the product association probability is used for representing a probability that the consumer associates “skin care” based on the “XX brand”. The second indicator includes a preference degree and a reputation degree, the preference degree is used for representing a probability that the consumer selects the “XX brand” among multiple brands in the “skin care” industry, and the preference degree may be used for representing an overall favor degree and/or a positive evaluation degree of the consumer to the “XX brand”, and may be determined by the following formula:

$$P = \frac{{Q}_{1} - {Q}_{2}}{{Q}_{1} + {Q}_{2} + {Q}_{3}} \times 100 \%$$

where Q₁ represents an amount of positive evaluation content of the consumer to the “XX brand”, Q₂ represents an amount of negative evaluation content of the consumer to the “XX brand”, and Q₃ represents an amount of neutral evaluation content of the consumer to the “XX brand”.

In the present embodiment, because the first indicator is used for representing the association probability of the user to the category to which the target object belongs and the target object, and the second indicator is used for representing the interaction indicator of the user for the target object in the category to which the target object belongs, the indicator information corresponding to the first indicator and/or the indicator information corresponding to the second indicator may intuitively reflect a cognition degree and behavioral preference of the user to the target object. Compared with the related art in which the cognition degree and behavioral preference of the user to the target object are acquired through manual statistical analysis, this method may simplify the operation complexity of the acquisition method and improve the acquisition efficiency.

In a possible implementation, displaying the target association information of the target object may include:
displaying a first page option for triggering to display the second association information, where the first page option includes at least one of a first option, a second option or a third option, the first option is used for triggering to display a preset number of attribute words of the target object that satisfy a first preset condition, the second option is used for triggering to display a custom attribute word of the target object, and the third option is used for triggering to display a product function attribute word of the target object; and in response to a trigger operation on a first target option in the first page option, displaying a target attribute word corresponding to the first target option and target indicator information, the target indicator information being used for measuring an association cognition degree of the user to the target attribute word and the target object.

In the present embodiment, the association cognition degree of the user to the target attribute word and the target object may be an intensity and accuracy of the user to establish an association between the target attribute word and the target object when the user is exposed to the target object or the target attribute word. The association cognition degree may be measured in various ways, such as a probability that the user may associate the target attribute word when the user sees the target object, or a probability that the user may associate the target object when the user sees the target attribute word, and certainly may also be measured in other ways, which is not limited in the embodiments of the present disclosure. Exemplarily, when the target object is the “XX brand” and the target attribute word is the mind word “Vitamin C for morning and Vitamin A for evening” of the “XX brand”, the association cognition degree may include a first association cognition degree and a second association cognition degree, where the first association cognition degree may be a probability that a consumer associates “Vitamin C for morning and Vitamin A for evening” based on the “XX brand”, and the second association cognition degree may be a probability that the consumer associates the “XX brand” based on “Vitamin C for morning and Vitamin A for evening”.

In the present embodiment, the first preset condition and the preset number may be determined according to actual situations, which is not limited in the embodiments of the present disclosure. Exemplarily, the first preset condition may be that when each attribute word of the target object is ranked according to a preset indicator associated with the attribute word, the ranking of the attribute word is before a preset ranking, where the preset ranking is determined according to the preset number. Alternatively, the first preset condition may be an attribute word with a preset indicator associated with the attribute word being greater than a preset indicator value among multiple attribute words of the target object. Certainly, the first preset condition may also be other conditions, which is not limited in the embodiments of the present disclosure. The preset indicator may be determined according to actual situations, which is not limited in the embodiments of the present disclosure, and for example, the preset indicator may be the first association cognition degree or the second association cognition degree.

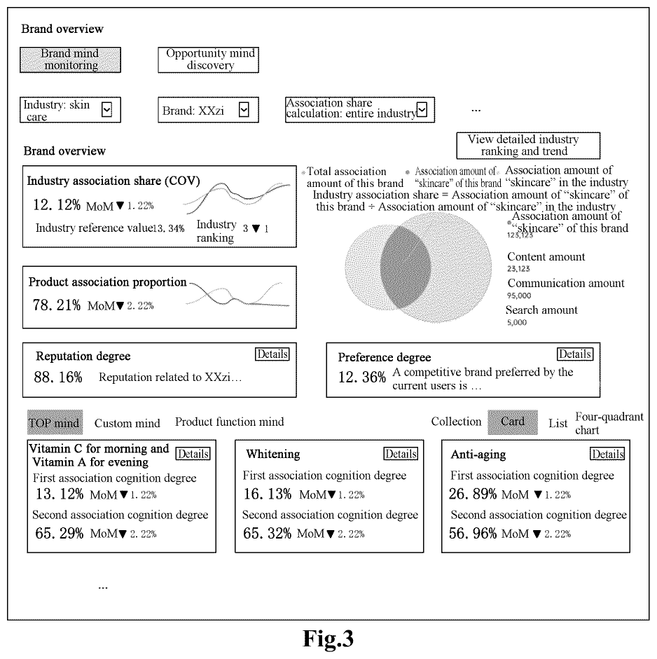

Exemplarily, still referring to the above example, the first option “TOP mind”, the second option “custom mind”, and the third option “product function mind” may be displayed in a display area below a display position of the first association information. If the preset number is 20, and the first preset condition is: when each mind word of the “XX brand” is ranked according to the first association cognition degree, the ranking of the mind word is before the 21st ranking, then when the first option “TOP mind” is triggered through an operation such as clicking, 20 mind words that meet the first preset condition and the target indicator information corresponding to each mind word may be displayed, as shown in FIG. 3. When the second option “custom mind” is triggered through an operation such as clicking, the custom mind word and the target indicator information corresponding to each custom mind word may be displayed. When the third option “product function mind word” is triggered through an operation such as clicking, the product function mind word and the target indicator information corresponding to each product function mind word may be displayed. For the display style of the product function mind word and the corresponding target indicator information, please refer to FIG. 3, and for the display style of the custom mind word and the corresponding target indicator information, please refer to FIG. 3.

It should be understood that there are many attribute words of the target object, but the number of attribute words that may be viewed through the first page option is limited. Therefore, in order to be able to quickly view the attribute words of the target object, a search control may also be displayed, so that the attribute words of the target object may be searched through the search control, so as to quickly display the searched attribute words and the corresponding target indicator information. Alternatively, in order to be able to quickly view attribute words that a second user (such as a brand party) pays attention to, the object management page may also support a function of collecting attribute words and a function of viewing the collected attribute words, thereby optimizing the user experience and improving the management efficiency of the target object.

In the present embodiment, displaying the target attribute word corresponding to the first target option and the target indicator information may be: after the first target option is triggered, simultaneously displaying the target attribute word corresponding to the first target option and the target indicator information; or may be: first displaying the target attribute word corresponding to the first target option, and then when the display of the target attribute word meets a preset condition, displaying the corresponding target indicator information, and certainly may also be other manners, which is not limited in the embodiments of the present disclosure. The preset condition may be that the display duration of the target attribute word reaches a preset display duration, or may be that a click operation, a hover operation or a slide operation is performed on the target attribute word.

In a possible implementation, in response to the trigger operation on the first target option in the first page option, displaying the target attribute word corresponding to the first target option and the target indicator information may include:
in response to the trigger operation on the first target option in the first page option, displaying the target attribute word corresponding to the first target option; and in response to a trigger operation on the target attribute word, displaying the target indicator information.

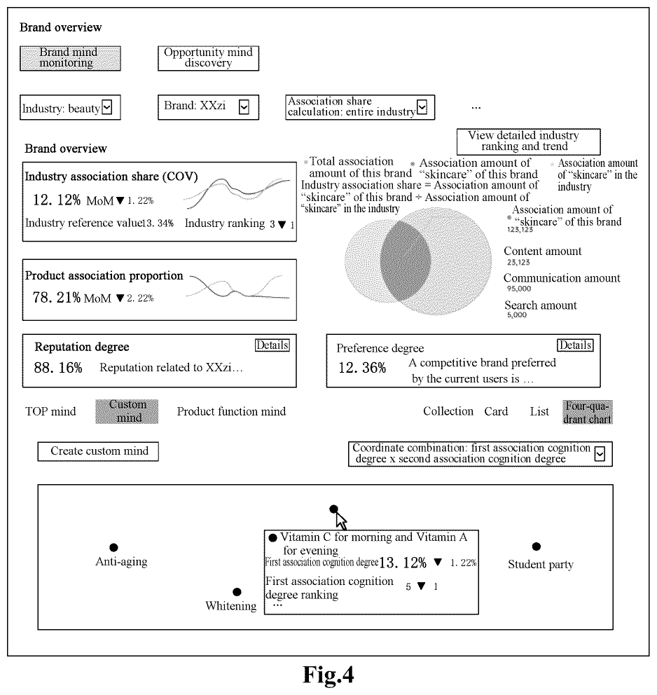

Exemplarily, still referring to the above example, when the second option “custom mind” is triggered through an operation such as clicking, multiple custom mind words may be displayed. When the custom mind word “Vitamin C for morning and Vitamin A for evening” is triggered through an operation such as clicking, the target indicator information for the custom attribute word “Vitamin C for morning and Vitamin A for evening” may be displayed in a panel, as shown in FIG. 4.

Through the above manner, after the first target option is triggered, the target attribute word may be first displayed, and after the target attribute word is triggered, the corresponding target indicator information may be displayed, so that hierarchical information display may be realized, thereby the corresponding target indicator information may be displayed based on requirements of different inquirers, and the user experience and information acquisition efficiency may be improved.

In a possible implementation, the information display method may further include:
in response to the trigger operation on the target attribute word, displaying a change trend of the target indicator information with time, and/or, displaying ranking information of the target object in the category to which the target object belongs based on the target indicator information.

As mentioned above, the target indicator information is used for measuring the association cognition degree of the user to the target attribute word and the target object, and the association cognition degree may include the first association cognition degree (that is, the probability of associating the target attribute word based on the target object) and/or the second association cognition degree (that is, the probability of associating the target object based on the target attribute word). Therefore, in the present embodiment, the change trend of the target indicator information with time may be a change trend of the first association cognition degree and/or the second association cognition degree with time. Correspondingly, the ranking information of the target object in the category to which the target object belongs based on the target indicator information may be ranking information of the target object in the category to which the target object belongs based on the first association cognition degree and/or the second association cognition degree.

In the present embodiment, the change trend may be displayed in text or in a chart, and certainly may also be displayed in other manners, which is not limited in the embodiments of the present disclosure. In a possible implementation, in order to intuitively present fluctuations and change rules of the target indicator information, the change trend may be displayed in a form of line chart, histogram, area chart or the like.

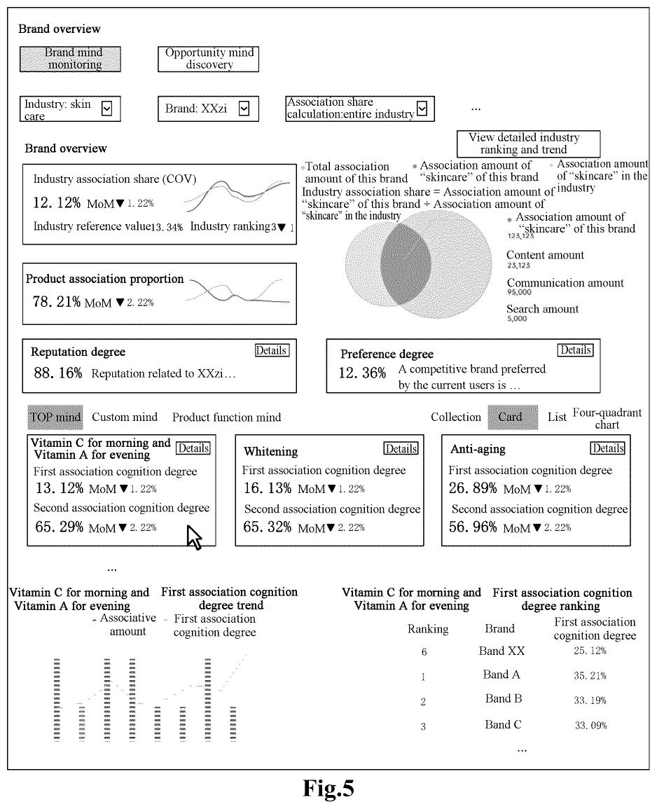

Exemplarily, still referring to the above example, when the mind word “Vitamin C for morning and Vitamin A for evening” is triggered through an operation such as clicking, the change trend of the first association cognition degree with time within a preset time period may be displayed in a chart, and the ranking information of the “XX brand” in the skin care industry based on the first association cognition degree may be displayed, as shown in FIG. 5.

Through the above manner, the change trend of the target indicator information with time and/or the ranking information of the target object in the category to which the target object belongs based on the target indicator information may be displayed when the target attribute word is triggered, so that a more intuitive, dynamic and comprehensive data analysis experience may be provided. When the target object is a brand, the cognition information of the consumer to the brand may be more comprehensively gained insight into through the above manner.

In a possible implementation, the information display method may further include:
associatively displaying a first control with the target attribute word, where the first control is at least used for triggering to display association cognition details of the user to the target attribute word and the target object;
and in response to a trigger operation on the first control, displaying a first detail page and displaying the association cognition details of the user to the target attribute word and the target object on the first detail page.

In the present embodiment, associatively displaying the first control with the target attribute word may be associatively displaying one first control with each target attribute word, or may be associatively displaying one first control with all target attribute words, and certainly may also be other manners, which is not limited in the embodiments of the present disclosure. When one first control is associatively displayed with each target attribute word, the association cognition details corresponding to the target attribute word associated with the first control are displayed in response to the trigger operation on the first control. When one first control is associatively displayed with all target attribute words, a selection control for selecting an attribute word may be displayed in response to the trigger operation on the first control, and after a certain target attribute word is selected from the target attribute words through the selection control, the association cognition details corresponding to the target attribute word are displayed.

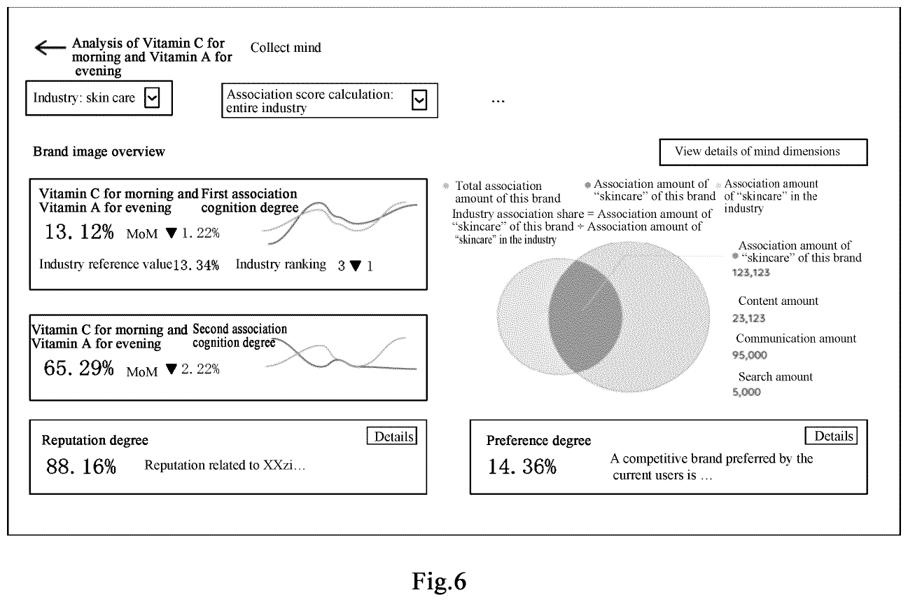

Exemplarily, still referring to the above example, one first control “details” may be associatively displayed with each target mind word, as shown in FIG. 5. When the first control “details” associated with “Vitamin C for morning and Vitamin A for evening” is triggered through an operation such as clicking, the first detail page may be displayed, and the association cognition details of the consumer to “Vitamin C for morning and Vitamin A for evening” and the “XX brand” may be displayed on the first detail page, as shown in FIG. 6.

Through the above manner, the first control may be associatively displayed with the target attribute word, and the association cognition details of the user to the target attribute word and the target object may be displayed when the first control is triggered, thereby avoiding displaying too much information at one time when the first target option is triggered and reducing the reading interest of the user. In addition, by displaying the first control, the user may independently choose whether to view the association cognition details, thereby enhancing the user experience.

In a possible implementation, the information display method may further include:
displaying a second page option on the first detail page, where the second page option is used for triggering to display comparison information between different objects in the category to which the target object belongs based on a comparison dimension, the different objects include the target object, and the comparison dimension includes an indicator dimension obtained based on the target indicator information; in response to a trigger operation on the second page option, displaying a first configuration control for configuring the comparison dimension; and in response to a first configuration operation on the comparison dimension in the first configuration control, displaying the comparison information between the different objects according to the comparison dimension corresponding to the first configuration operation.

As mentioned above, the target indicator information may include the first association cognition degree and the second association cognition degree, and therefore, the comparison dimension may be a one-dimensional comparison dimension, for example, the first association cognition degree or the second association cognition degree may be used as the comparison dimension, so as to realize an intuitive comparison between different objects in a single indicator dimension. The comparison dimension may also be a two-dimensional comparison dimension, for example, the first association cognition degree may be used as an abscissa, and the second association cognition degree may be used as an ordinate to construct a two-dimensional coordinate system, so that the comprehensive performance of different objects in the bidirectional association cognition degree may be intuitively displayed through the position distribution of the different objects in the two-dimensional coordinate system.

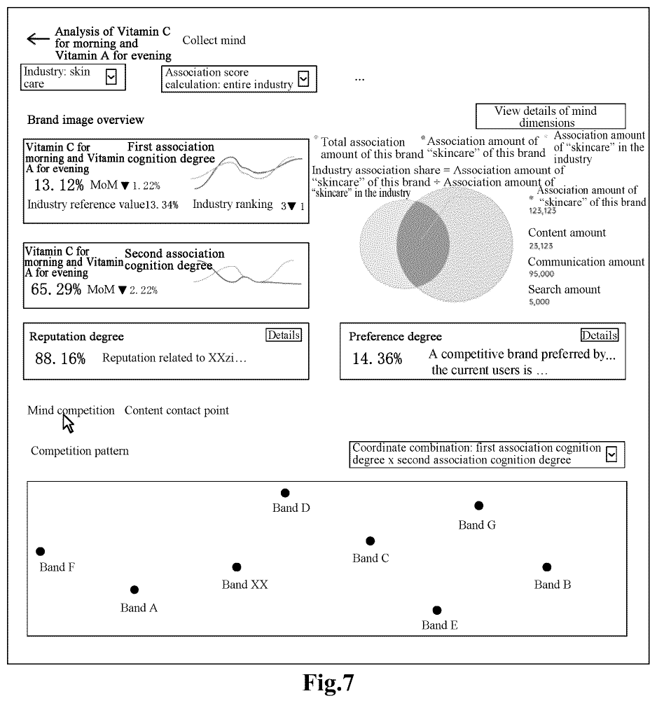

Exemplarily, still referring to the above example, the second page option “mind competition” may be displayed in the display area below the association cognition detail display area, and when the second page option “mind competition” is triggered through an operation such as clicking, the first configuration control “coordinate combination” for configuring the comparison dimension is displayed, and after the configuration of the comparison dimension is completed through the first configuration control “coordinate combination”, the comparison information between different brands is displayed, as shown in FIG. 7.

It should be understood that the above description is only illustrative and does not constitute a limitation on the solution. When the indicator dimension obtained based on the target indicator information further includes other indicators, the configuration of the comparison dimension may also be based on the other indicators.

Through the above manner, the comparison dimension between the different objects may be customized and configured in a visual manner, so that the user may select the comparison dimension according to his/her own needs to intuitively view the performance differences between the different objects in the comparison dimension. For example, when the target object is a brand, comparative analysis with a competitive brand may be performed through the above manner, so as to discover the advantages and disadvantages between the own brand and the competitive brand, and then the brand strategy may be adjusted in a targeted manner.

In a possible implementation, the information display method may further include:
displaying a third page option on the first detail page, where the third page option is used for triggering to display multimedia content related to the target object; and in response to a trigger operation on the third page option, displaying a multimedia content list, where the multimedia content list includes a first list and a second list, the first list is used for displaying multimedia content for which association cognition information of the user to the target object satisfies a second preset condition and/or play information of the target object satisfies a third preset condition, and the second list is used for displaying multimedia content for which the association cognition information of the user to the target object does not satisfy the second preset condition and/or the play information of the target object does not satisfy the third preset condition.

In the present embodiment, the multimedia content may be a video, an audio, a picture, or may be other content, which is not limited in the embodiments of the present disclosure.

In the present embodiment, the second preset condition may be determined according to actual situations, which is not limited in the embodiments of the present disclosure. Exemplarily, the association cognition information of the user to the target object may further include indicator information corresponding to a fifth indicator and/or indicator information corresponding to a sixth indicator, where the fifth indicator may be used for representing association efficiency of the user to associate the target object based on the multimedia content during the playing of the multimedia content related to the target object, and the sixth indicator may be used for representing an association amount of the user to associate the target object based on the multimedia content in a preset number of plays of the multimedia content related to the target object. Therefore, that the association cognition information of the user to the target object satisfies the second preset condition may mean that an indicator value corresponding to the fifth indicator is greater than a preset first indicator value, or may mean that an indicator value corresponding to the sixth indicator is greater than a preset second indicator value, or may mean that the indicator value corresponding to the fifth indicator is greater than the first indicator value and the indicator value corresponding to the sixth indicator is greater than the second indicator value, and certainly may also mean other conditions, which is not limited in the embodiments of the present disclosure. Correspondingly, that the association cognition information of the user to the target object does not satisfy the second preset condition may mean that the indicator value corresponding to the fifth indicator is less than or equal to the first indicator value, or may mean that the indicator value corresponding to the sixth indicator is less than or equal to the second indicator value, or may mean that the indicator value corresponding to the fifth indicator is greater than the first indicator value and the indicator value corresponding to the sixth indicator is less than or equal to the second indicator value, and certainly may also mean other conditions, which is not limited in the embodiments of the present disclosure.

Similarly, the third preset condition may also be determined according to actual situations, which is not limited in the embodiments of the present disclosure. Exemplarily, the play information may include the play volume and/or the play duration, and therefore, that the play information of the target object satisfies the third preset condition may mean that the play volume is greater than a preset play volume threshold, or may mean that the play duration is greater than a preset play duration threshold, or may mean that the play volume is greater than the play volume threshold and the play duration is greater than the preset play duration threshold, and certainly may also mean other conditions, which is not limited in the embodiments of the present disclosure. Correspondingly, that the play information of the target object does not satisfy the third preset condition may mean that the play volume is less than or equal to the preset play volume threshold, or may mean that the play duration is less than or equal to the preset play duration threshold, or may mean that the play volume is greater than the play volume threshold and the play duration is less than or equal to the preset play duration threshold, and certainly may also mean other conditions, which is not limited in the embodiments of the present disclosure.

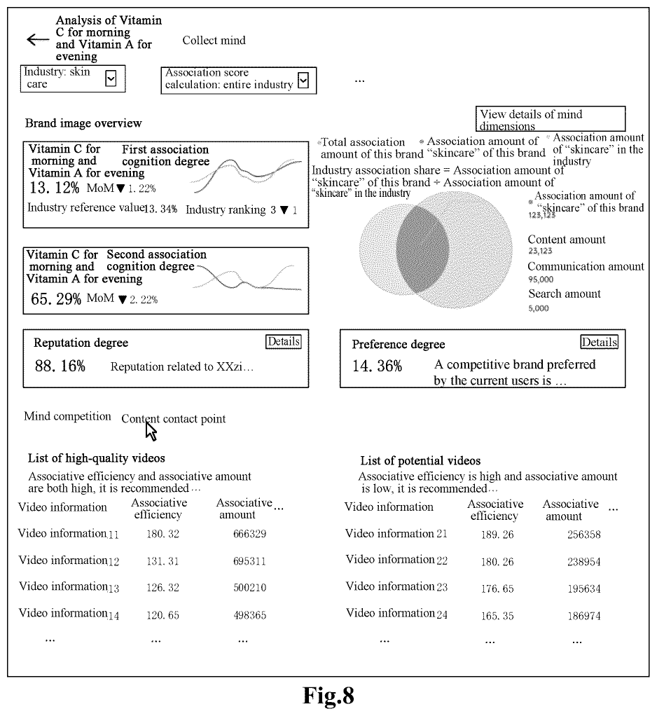

Exemplarily, still referring to the above example, the third page option “content contact point” may be displayed in the display area below the association cognition detail display area, and when the third page option “content contact point” is triggered through an operation such as clicking, the first list and the second list may be displayed, where the first list may be used for displaying video content which is related to the “XX brand” and for which the indicator value corresponding to the fifth indicator is greater than the first indicator value and the indicator value corresponding to the sixth indicator is greater than the second indicator value, and the second list may be used for displaying video content which is related to the “XX brand” and for which the indicator value corresponding to the fifth indicator is greater than the first indicator value and the indicator value corresponding to the sixth indicator is less than or equal to the second indicator value, as shown in FIG. 8.

In a possible implementation, the information display method may further include:
displaying a fourth page option on the first detail page, the fourth page option being used for triggering to display delivery channel information of the target object; and in response to a trigger operation on target delivery channel information in the delivery channel information, displaying a change trend of an association degree of the user to the target object with time under a delivery channel corresponding to the target delivery channel information.

In the present embodiment, the delivery channel information may include a delivery channel name of the target object, delivery duration, delivery frequency and/or delivery content of the target object under a single delivery channel, and certainly may also include other information, which is not limited in the embodiments of the present disclosure.

In the present embodiment, the association degree may be used for representing a probability or the number of times that the user associates the target object when the target object reaches the user through the delivery channel, and certainly may also represent other aspects, which is not limited in the embodiments of the present disclosure.

In the present embodiment, the change trend may be displayed in text or in a chart, and certainly may also be displayed in other forms, which is not limited in the embodiments of the present disclosure. In a possible implementation, in order to intuitively present fluctuations and change rules of the association degree, the change trend may be displayed in a form of line chart, histogram, area chart or the like.

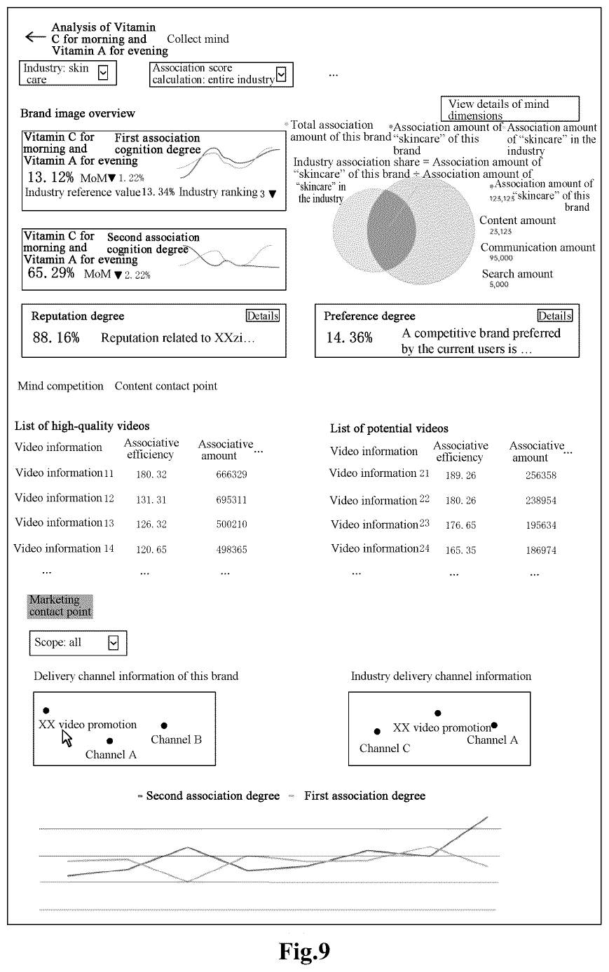

Exemplarily, still referring to the above example, the fourth page option “marketing contact point” may be displayed in a display area below the multimedia content list display area, and therefore, when the fourth page option “marketing contact point” is triggered through an operation such as clicking, the delivery channels of the “XX brand” may be displayed, and when the delivery channel “XXX video promotion” is triggered through an operation such as clicking, the change trend of the association degree of the consumers to the “XX brand” with time under the delivery channel “XXX video promotion” may be displayed in a data chart, as shown in FIG. 9.

In a possible implementation, in order to be able to learn the delivery channel information of other objects in the category to which the target object belongs, when the fourth page option is triggered, the delivery channel information of the other objects in the category to which the target object belongs may also be displayed, as shown in FIG. 9.

Through the above manner, the change trend of the association degree of the user to the target object with time under the delivery channel corresponding to the target delivery channel information may be displayed after the target delivery channel information is triggered. On the one hand, the cognition change of the user to the target object may be discovered in time according to the change trend, and on the other hand, the delivery strategy for the target object may be adjusted according to the change trend, for example, changing the delivery channel or increasing the delivery content, so as to improve the effect of the content delivery for the target object.

In a possible implementation, displaying the target attribute word corresponding to the first target option and the target indicator information may include:
displaying the target attribute word corresponding to the first target option and the target indicator information in a first display style; and in response to a switch operation on the display style, determining a second display style corresponding to the switch operation, and displaying the target attribute word corresponding to the first target option and the target indicator information in the second display style, where the second display style is different from the first display style.

In the present embodiment, the first display style may be a card style, a list style, a four-quadrant chart style, and certainly may also be other display styles, which is not limited in the embodiments of the present disclosure. Correspondingly, the second display style may be a card style, a list style, a four-quadrant chart style, and certainly may also be other display styles, which is not limited in the embodiments of the present disclosure.

Exemplarily, as shown in FIG. 3, a card style option “card”, a list style option “list” and a four-quadrant chart style option “four-quadrant chart” may be displayed in a display area on the right side of the first page option, so that the display style may be switched by triggering different style options. For example, when the target attribute word corresponding to the first target option and the target indicator information are displayed in the object management page in the card style, the list style option “list” may be triggered through an operation such as clicking, so as to display the target attribute word corresponding to the first target option and the target indicator information in the list style in the object management page.

In a possible implementation, the custom attribute word of the target object is configured as follows: displaying a second configuration control, the second configuration control being used for adding the custom attribute word for the target object; and in response to a configuration operation through the second configuration control, determining a first attribute word to be added and/or a second attribute word to be excluded, and determining the custom attribute word of the target object according to the first attribute word and/or the second attribute word.

In the present embodiment, determining the custom attribute word of the target object according to the first attribute word and/or the second attribute word may be: after the first attribute word and/or the second attribute word are determined, directly determining the custom attribute word of the target object based on the first attribute word and/or the second attribute word; or may be: after the first attribute word and/or the second attribute word are determined, first expanding the first attribute word and/or the second attribute word based on a machine learning model (for example, a large language model) to obtain an expanded word of the first attribute word and/or an expanded word of the second attribute word, and then determining the custom attribute word of the target object based on the first attribute word and the expanded word of the first attribute word, and/or determining the custom attribute word of the target object based on the second attribute word and the expanded word of the second attribute word. Certainly, the custom attribute word of the target object may also be determined according to the first attribute word and/or the second attribute word in other manners, which is not limited in the embodiments of the present disclosure.

In a possible implementation, the information display method may further include:
displaying a second control, the second control being used for triggering to display ranking information of the target object in the category to which the target object belongs based on the first association information; in response to a trigger operation on the second control, displaying a second detail page and displaying ranking information of the target object under a third indicator included in the first association information on the second detail page; and in response to a selection operation for a fourth indicator included in the first association information on the second detail page, switching and displaying the ranking information displayed on the second detail page to ranking information of the target object under the fourth indicator.

In the present embodiment, the third indicator and the fourth indicator may be determined according to actual situations, which is not limited in the embodiments of the present disclosure. Exemplarily, the third indicator may be one of the reputation degree, the industry association probability or the preference degree, and the fourth indicator may be one of the product association probability, the preference degree or the reputation degree, and the third indicator is different from the fourth indicator. Certainly, the third indicator and the fourth indicator may also refer to other indicators, which is not limited in the embodiments of the present disclosure.

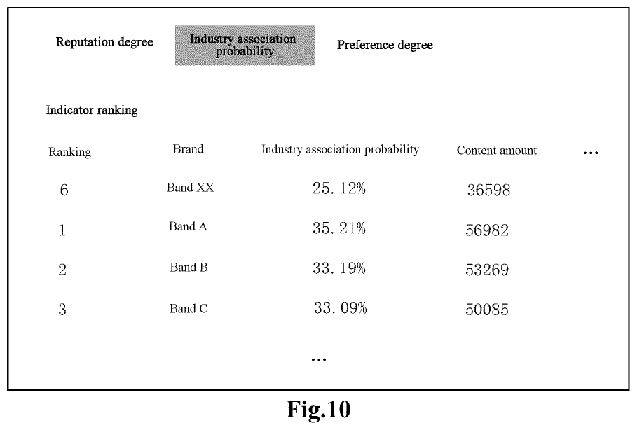

Exemplarily, still referring to the above example, the second control “view detailed industry ranking and trend” may be displayed in the display area of the first association information, and therefore, when the second control “view detailed industry ranking and trend” is triggered through an operation such as clicking, the second detail page may be displayed, and the ranking information of the “XX brand” under the third indicator “reputation degree” may be displayed on the second detail page, and when the fourth indicator “industry association probability” is triggered through an operation such as clicking, the ranking information of the “XX brand” under the fourth indicator “industry association probability” is displayed, as shown in FIG. 10. For the display manner of the ranking information of the “XX brand” under the third indicator “reputation degree”, reference may be made to FIG. 10.

Through the above manner, the ranking information of the target object under different indicators included in the first association information may be viewed on the second detail page, so that the data information of the target object may be learned from different indicator dimensions, and thus the data information of the target object may be more comprehensively learned, and then the cognition information of the user to the target object may be more accurately measured.

In a possible implementation, the information display method may further include:
in response to a trigger operation on ranking information corresponding to the target object in the ranking information, displaying data detail information of the target object under the fourth indicator, the data detail information including indicator information corresponding to multiple disassembly indicators obtained by disassembling the fourth indicator; and in response to a trigger operation on target indicator information in the data detail information, displaying multimedia content, where the target indicator information is obtained based on the multimedia content.

In the present embodiment, the disassembly indicators may be the content amount, the search amount, the communication amount, and the like, and certainly, the disassembly indicators may also be other indicators, which is not limited in the embodiments of the present disclosure. The content amount may be used for representing the number of pieces of content related to the target object, the search amount may be used for representing the number of searches for the target object, and the communication amount may be used for representing the number of interactions of the user for the content related to the target object, such as the number of likes, the number of comments, the number of clicks and/or the number of shares.

In the present embodiment, the indicator information corresponding to each disassembly indicator may include a disassembly indicator name, an indicator value corresponding to the disassembly indicator, or an average value corresponding to the disassembly indicator in the category to which the target object belongs, and certainly, the indicator information corresponding to each disassembly indicator may also include other information, which is not limited in the embodiments of the present disclosure.

In the present embodiment, the multimedia content may be a video, an audio, a picture, or may be other content, which is not limited in the embodiments of the present disclosure.

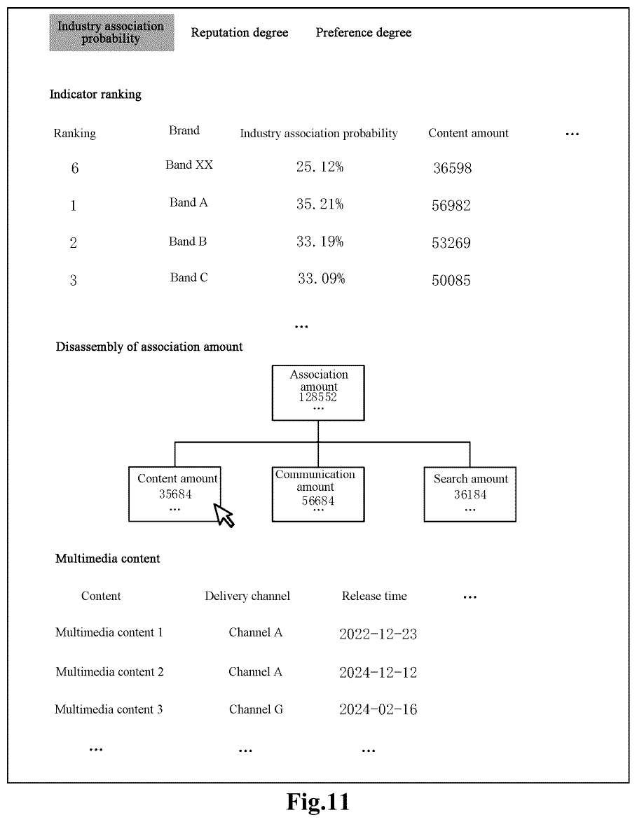

Exemplarily, still referring to the above example, after the ranking information corresponding to the “XX brand” is triggered through an operation such as clicking in the ranking information, the data detail information of the “XX brand” under the fourth indicator “industry association probability” may be displayed on the second detail page, where the data detail information includes indicator information corresponding to the disassembly indicator “content amount”, indicator information corresponding to the disassembly indicator “search amount”, indicator information corresponding to the disassembly indicator “communication amount” and indicator information corresponding to the fourth indicator “industry association probability”. When the indicator information corresponding to the disassembly indicator “content amount” is triggered through an operation such as clicking, the multimedia content for the disassembly indicator “content amount” may be displayed on the second detail page, as shown in FIG. 11, where the association amount is the association amount corresponding to the industry association probability, that is, the number of pieces of multimedia content in which the “XX brand” is associated among the preset number of pieces of multimedia content.

In a possible implementation, the information display method may further include:
displaying a third control in the object management page, the third control being used for triggering to display attribute word information for the target object, the attribute word information including first attribute word information, and the first attribute word information being used for indicating information of an attribute word that needs attention in the target object; and in response to a trigger operation on the third control in the object management page, displaying the attribute word information for the target object.

In the present embodiment, the attribute word that needs attention may be an attribute word for which target indicator information corresponding to the attribute word satisfies a preset condition, or may be a pre-marked attribute word, and certainly may also be other attribute word, which is not limited in the embodiments of the present disclosure. When the attribute word that needs attention is an attribute word for which the target indicator information corresponding to the attribute word satisfies the preset condition, the attribute word that needs attention may be an attribute word with an association cognition degree greater than or less than a preset association cognition degree, or may be other attribute word, which is not limited in the embodiments of the present disclosure.

In the present embodiment, the information of the attribute word that needs attention may include the attribute word that needs attention, a data indicator associated with the attribute word, and/or an optimization suggestion, and the like.

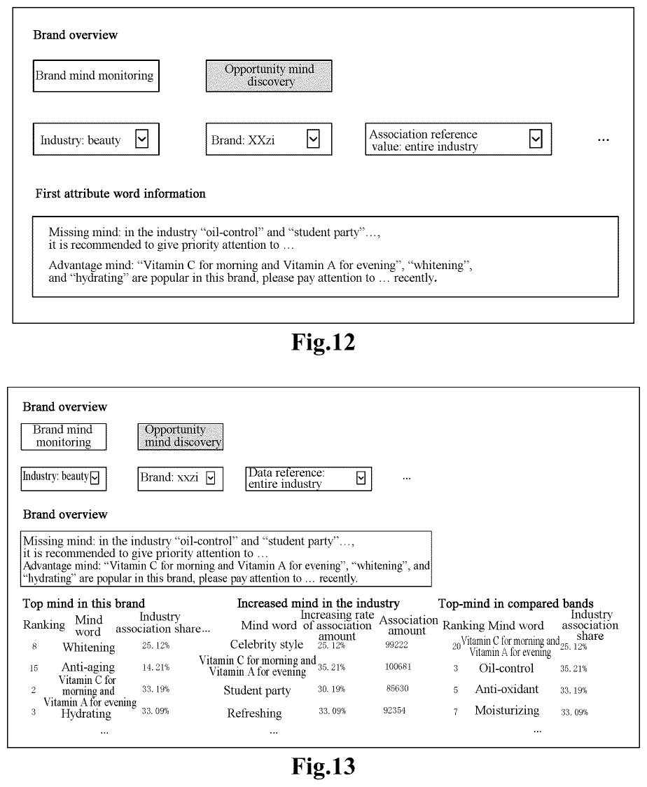

Exemplarily, still referring to the above example, the third control “opportunity mind discovery” may be displayed in the object management page, and therefore, when the third control “opportunity mind discovery” is triggered through an operation such as clicking, the first attribute word information may be displayed, as shown in FIG. 12.

Through the above manner, the first attribute word information may be displayed after the third control is triggered, and the first attribute word information may be used for indicating the information of the attribute word that needs attention in the target object, so that the key attribute word of the target object may be quickly located based on the first attribute word information. Compared with the related art in which the key attribute word is located through manual statistics, the operation complexity of locating the key attribute word may be simplified, the efficiency of locating the key attribute word may be improved, and the user experience may be further improved.

In a possible implementation, the attribute word information may further include second attribute word information, the second attribute word information being used for indicating at least one of the following information:
information of a preset number of attribute words of the target object that satisfy a fourth preset condition; information of a preset number of attribute words that satisfy the fourth preset condition in other objects than the target object in the category to which the target object belongs; and information of a preset number of attribute words that satisfy the fourth preset condition in the category to which the target object belongs.

In the present embodiment, the fourth preset condition and the preset number may be determined according to actual situations, which is not limited in the embodiments of the present disclosure. Exemplarily, the fourth preset condition may be that when each attribute word of the target object is ranked according to a preset indicator associated with the attribute word, the ranking of the attribute word is before a preset ranking, where the preset ranking is determined according to the preset number. Alternatively, the fourth preset condition may be an attribute word with a preset indicator associated with the attribute word being greater than a preset indicator value among multiple attribute words of the target object. Certainly, the fourth preset condition may also be other conditions, which is not limited in the embodiments of the present disclosure. The preset indicator may be determined according to actual situations, which is not limited in the embodiments of the present disclosure, and for example, the preset indicator may be the first association cognition degree or the second association cognition degree.

Exemplarily, still referring to the above example, when the third control “opportunity mind discovery” is triggered through an operation such as clicking, the first attribute word information may be displayed, and the second attribute word information may be displayed in a display area below the display area of the first attribute word information, as shown in FIG. 13. The fourth preset condition is used for representing a mind word whose ranking is before the 21st ranking when the mind words are ranked according to the first association cognition degree associated with the mind words.

Through the above manner, it is possible to display the information of the attribute word of the target object that satisfies the fourth preset condition, the information of the attribute word that satisfies the fourth preset condition in other objects than the target object in the category to which the target object belongs, and the information of the attribute word that satisfies the fourth preset condition in the category to which the target object belongs, so that comparative analysis may be performed from three dimensions of the target object, the category to which the target object belongs and a competitive object, and thus the competitiveness of the target object in the category to which the target object belongs may be more comprehensively understood. Compared with the related art in which analysis and statistics are performed manually, the efficiency of analysis and statistics may be improved on the one hand, and on the other hand, statistical deviation caused by subjective factors may be reduced, and the accuracy of analysis and statistics results may be improved.

It should be understood that during specific implementation, the object management page may integrate all the above functions, or may integrate some of the above functions, which is not limited in the embodiments of the present disclosure. In addition, in a possible implementation, in order to facilitate that a manager of the target object (such as a brand party or a streamer) may learn the target association information of the target object when the target association information of the target object changes greatly or periodically, the object association page may also support a subscription function, so that when the target association information of the target object changes greatly or a preset period is reached, the target association information of the target object may be automatically pushed to the manager of the target object, thereby further improving the user experience.

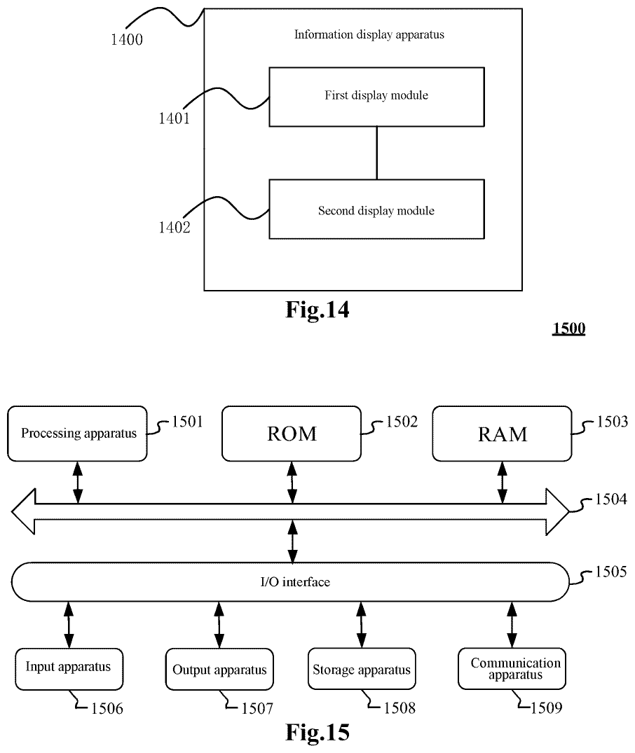

Based on the same concept, an embodiment of the present disclosure further provides an information display apparatus. As shown in FIG. 14, the information display apparatus 1400 includes:
a first display module 1401, configured to display an object management page for managing a target object; and a second display module 1402, configured to, in response to a trigger operation on association information of the target object in the object management page, display target association information of the target object, where the target association information is used for representing an association cognition of a user to the target object, the target association information includes first association information and/or second association information, the first association information is used for representing association cognition information of the user to a category to which the target object belongs and the target object, and the second association information is used for representing association cognition information of the user to an attribute word of the target object and the target object.

Through the above information display apparatus 1400, the target association information used for representing the association cognition of the user to the target object may be displayed when the association information of the target object is triggered in the object management page, and therefore, the target association information of the target object may be quickly acquired through a simple interaction operation. In addition, because the target association information may include the information used for representing the association cognition information of the user to the category to which the target object belongs and the target object, and/or the information used for representing the association cognition information of the user to the attribute word of the target object and the target object, the association cognition of the user to the target object may be acquired from different dimensions, thereby improving the comprehensiveness and accuracy of the statistical analysis. For example, when the target object is a brand, through the above technical solution, the cognition information of a consumer to the brand may be quickly acquired through a simple interaction operation. Compared with the related art in which the cognition information of the consumer to the brand is acquired through manual statistics, this method simplifies the operation complexity of acquiring the cognition information and improves the efficiency of acquiring the cognition information. Meanwhile, through multi-dimensional data association analysis, the cognition information of the consumer to the brand may be more comprehensively gained insight into, and the accuracy of the cognition information may be improved.

In a possible implementation, the first association information includes indicator information corresponding to a first indicator and/or indicator information corresponding to a second indicator, the first indicator is used for representing an association probability of the user to the category to which the target object belongs and the target object, and the second indicator is used for representing an interaction indicator of the user for the target object in the category to which the target object belongs.

In a possible implementation, the second display module 1402 may include:
a first display sub-module, configured to display a first page option for triggering to display the second association information, where the first page option includes at least one of a first option, a second option or a third option, the first option is used for triggering to display a preset number of attribute words of the target object that satisfy a first preset condition, the second option is used for triggering to display a custom attribute word of the target object, and the third option is used for triggering to display a product function attribute word of the target object; and
a second display sub-module, configured to, in response to a trigger operation on a first target option in the first page option, display a target attribute word corresponding to the first target option and target indicator information, the target indicator information being used for measuring an association cognition degree of the user to the target attribute word and the target object.

In a possible implementation, the second display sub-module may include:
a first display unit, configured to, in response to the trigger operation on the first target option in the first page option, display the target attribute word corresponding to the first target option; and
a second display unit, configured to, in response to a trigger operation on the target attribute word, display the target indicator information.

In a possible implementation, the second display module 1402 may further include:
a third display sub-module, configured to, in response to the trigger operation on the target attribute word, display a change trend of the target indicator information with time, and/or, display ranking information of the target object in the category to which the target object belongs based on the target indicator information.

In a possible implementation, the second display module 1402 may further include:
a fourth display sub-module, configured to associatively display a first control with the target attribute word, where the first control is at least used for triggering to display association cognition details of the user to the target attribute word and the target object; and
a fifth display sub-module, configured to, in response to a trigger operation on the first control, display a first detail page, and display the association cognition details of the user to the target attribute word and the target object on the first detail page.

In a possible implementation, the second display module 1402 may further include:
a sixth display sub-module, configured to display a second page option on the first detail page, where the second page option is used for triggering to display comparison information between different objects in the category to which the target object belongs based on a comparison dimension, the different objects include the target object, and the comparison dimension includes an indicator dimension obtained based on the target indicator information;
a seventh display sub-module, configured to, in response to a trigger operation on the second page option, display a first configuration control for configuring the comparison dimension; and
an eighth display sub-module, configured to, in response to a first configuration operation on the comparison dimension in the first configuration control, display the comparison information between the different objects according to the comparison dimension corresponding to the first configuration operation.

In a possible implementation, the second display module 1402 may further include:
a ninth display sub-module, configured to display a third page option on the first detail page, where the third page option is used for triggering to display multimedia content related to the target object; and
a tenth display sub-module, configured to, in response to a trigger operation on the third page option, display a multimedia content list, where the multimedia content list includes a first list and a second list, the first list is used for displaying multimedia content for which association cognition information of the user to the target object satisfies a second preset condition and/or play information of the target object satisfies a third preset condition, and the second list is used for displaying multimedia content for which the association cognition information of the user to the target object does not satisfy the second preset condition and/or the play information of the target object does not satisfy the third preset condition.

In a possible implementation, the second display module 1402 may further include:
an eleventh display sub-module, configured to display a fourth page option on the first detail page, the fourth page option being used for triggering to display delivery channel information of the target object; and
a twelfth display sub-module, configured to, in response to a trigger operation on target delivery channel information in the delivery channel information, display a change trend of an association degree of the user to the target object with time under a delivery channel corresponding to the target delivery channel information.

In a possible implementation, the second display sub-module may include:
a third display unit, configured to display the target attribute word corresponding to the first target option and the target indicator information in a first display style; and
a fourth display unit, configured to, in response to a switch operation on the display style, determine a second display style corresponding to the switch operation, and display the target attribute word corresponding to the first target option and the target indicator information in the second display style, where the second display style is different from the first display style.

In a possible implementation, the custom attribute word of the target object may be obtainged by: displaying a second configuration control, the second configuration control being used for adding the custom attribute word for the target object; and in response to a configuration operation through the second configuration control, determining a first attribute word to be added and/or a second attribute word to be excluded, and determining the custom attribute word of the target object according to the first attribute word and/or the second attribute word.

In a possible implementation, the information display apparatus 1400 may further include:
a third display module, configured to display a second control, the second control being used for triggering to display ranking information of the target object in the category to which the target object belongs based on the first association information;
a fourth display module, configured to, in response to a trigger operation on the second control, display a second detail page, and display ranking information of the target object under a third indicator included in the first association information on the second detail page; and
a fifth display module, configured to, in response to a selection operation for a fourth indicator included in the first association information on the second detail page, switch and display the ranking information displayed on the second detail page to ranking information of the target object under the fourth indicator.

In a possible implementation, the information display apparatus 1400 may further include:
a sixth display module, configured to, in response to a trigger operation on ranking information corresponding to the target object in the ranking information, display data detail information of the target object under the fourth indicator, the data detail information including indicator information corresponding to multiple disassembly indicators obtained by disassembling the fourth indicator; and
a seventh display module, configured to, in response to a trigger operation on target indicator information in the data detail information, display multimedia content, where the target indicator information is obtained based on the multimedia content.

In a possible implementation, the information display apparatus 1400 may further include:
an eighth display module, configured to display a third control in the object management page, the third control being used for triggering to display attribute word information for the target object, the attribute word information including first attribute word information, and the first attribute word information being used for indicating information of an attribute word that needs attention in the target object; and
a ninth display module, configured to, in response to a trigger operation on the third control in the object management page, display the attribute word information for the target object.

In a possible implementation, the attribute word information further includes second attribute word information, and the second attribute word information is used for indicating at least one of the following information:
information of a preset number of attribute words of the target object that satisfy a fourth preset condition; information of a preset number of attribute words that satisfy the fourth preset condition in other objects than the target object in the category to which the target object belongs; and
information of a preset number of attribute words that satisfy the fourth preset condition in the category to which the target object belongs.

Based on the same concept, embodiments of the present disclosure further provide a computer readable medium having a computer program stored thereon, where when the program is executed by a processing apparatus, the steps of any one of the above information display methods are implemented.

Based on the same concept, embodiments of the present disclosure further provide an electronic device, which may include:
a storage apparatus having a computer program stored thereon; and
a processing apparatus, configured to execute the computer program in the storage apparatus to implement the steps of any one of the above information display methods.

Based on the same concept, embodiments of the present disclosure further provide a computer program product including a computer program, where when the computer program is executed by a processor, the steps of any one of the above information display methods are implemented.

Reference is made to FIG. 15 below, which illustrates a schematic diagram of a structure of an electronic device 1500 suitable for implementing an embodiment of the present disclosure. The terminal device in the embodiments of the present disclosure may include, but is not limited to, mobile terminals such as a mobile phone, a notebook computer, a digital broadcast receiver, a PDA (personal digital assistant), a PAD (tablet computer), a PMP (portable multimedia player), a vehicle-mounted terminal (for example, a vehicle navigation terminal), and so on, and fixed terminals such as a digital TV, a desktop computer, and so on. The electronic device shown in FIG. 15 is only an example, and should not impose any limitation on the function and scope of use of the embodiments of the present disclosure.

As shown in FIG. 15, the electronic device 1500 may include a processing apparatus (such as a central processing unit, a graphics processor and the like) 1501, which may perform various appropriate actions and processes according to a program stored in a read-only memory (ROM) 1502 or a program loaded from a storage apparatus 1508 into a random access memory (RAM) 1503. In the RAM 1503, various programs and data required for operations of the electronic device 600 are also stored. The processing apparatus 1501, the ROM 1502 and the RAM 1503 are connected to each other through a bus 1504. An input/output (I/O) interface 1505 is also connected to the bus 1504.

Usually, the following apparatuses may be connected to the I/O interface 1505: an input apparatus 1506 including, for example, a touch screen, a touchpad, a keyboard, a mouse, a camera, a microphone, an accelerometer, a gyroscope and the like; an output apparatus 1507 including, for example, a liquid crystal display (LCD), a speaker, a vibrator and the like; the storage apparatus 1508 including, for example, a magnetic tape, a hard disk and the like; and a communication apparatus 1509. The communication apparatus 1509 may allow the electronic device 1500 to perform wireless or wired communication with other devices to exchange data. Although FIG. 15 shows the electronic device 1500 having various apparatuses, it should be understood that it is not required to implement or have all the apparatuses shown. Alternatively, more or fewer apparatuses may be implemented or provided.

In particular, according to the embodiment of the present disclosure, the process described above with reference to the flowchart may be implemented as a computer software program. For example, the embodiment of the present disclosure includes a computer program product, which includes a computer program carried on a non-transitory computer readable medium, the computer program including program code for performing the method shown in the flowchart. In such an embodiment, the computer program may be downloaded and installed from a network through the communication apparatus 1509, or installed from the storage apparatus 1508, or installed from the ROM 1502. When the computer program is executed by the processing apparatus 1501, the above-mentioned functions defined in the method of the embodiment of the present disclosure are executed.

It should be noted that the above computer readable medium in the present disclosure may be a computer readable signal medium, a computer readable storage medium, or any combination thereof. The computer readable storage medium may be, for example, but is not limited to, an electrical, magnetic, optical, electromagnetic, infrared or semiconductor system, apparatus or device, or any combination thereof. More specific examples of the computer readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer readable storage medium may be any tangible medium that contains or stores a program, which may be used by or in combination with an instruction execution system, apparatus or device. In the present disclosure, the computer readable signal medium may include a data signal propagated on a baseband or as a part of a carrier wave, and computer readable program code is carried therein. This propagated data signal may adopt multiple forms, including but not limited to an electromagnetic signal, an optical signal, or any suitable combination thereof. The computer readable signal medium may also be any computer readable medium other than the computer readable storage medium, and the computer readable signal medium may send, propagate or transmit the program used by or in combination with the instruction execution system, apparatus or device. The program code contained on the computer readable medium may be transmitted by any suitable medium, including but not limited to: a wire, an optical cable, a radio frequency (RF), etc., or any suitable combination thereof.

In some implementations, any currently known or future developed network protocol, such as the hypertext transfer protocol (HTTP), may be used for communication, and interconnection with any form or medium of digital data communication (for example, a communication network) is possible. Examples of the communication network include a local area network (“LAN”), a wide area network (“WAN”), an internet (for example, the Internet), a peer-to-peer network (for example, an Ad-Hoc network), and any network currently known or to be developed in the future.

The above computer readable medium may be contained in the above electronic device, or may exist alone without being assembled into the electronic device.

The above computer readable medium carries one or more programs, and when the one or more programs are executed by the electronic device, the electronic device is caused to: display an object management page for managing a target object; and in response to a trigger operation on association information of the target object in the object management page, display target association information of the target object, where the target association information is used for representing an association cognition of a user to the target object, the target association information includes first association information and/or second association information, the first association information is used for representing association cognition information of the user to a category to which the target object belongs and the target object, and the second association information is used for representing association cognition information of the user to an attribute word of the target object and the target object.

The computer program code for performing the operations of the present disclosure may be written in one or more programming languages or a combination thereof, the above programming languages including but not limited to object-oriented programming languages such as Java, Smalltalk, C++, and conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions and operations of the system, the method and the computer program product according to various embodiments of the present disclosure. In this regard, each block in the flowchart or block diagram may represent a module, a program segment, or a part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved modules described in the embodiments of the present disclosure may be implemented in a form of software, and may also be implemented in a form of hardware. The name of a module does not constitute a limitation on the module itself under certain circumstances.

The functions described above herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD) and the like.

In the context of the present disclosure, a machine readable medium may be a tangible medium that may contain or store a program for use by or in combination with an instruction execution system, apparatus or device. The machine readable medium may be a machine readable signal medium or a machine readable storage medium. The machine readable medium may include, but is not limited to, an electronic, magnetic, optical, electromagnetic, infrared, or semiconductor system, apparatus or device, or any suitable combination of the above. More specific examples of the machine readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

The above description is only preferred embodiments of the present disclosure and an explanation of the technical principles employed. Those skilled in the art should understand that the scope of disclosure involved in the present disclosure is not limited to the technical solutions formed by the specific combination of the above technical features, and should also cover, without departing from the above disclosed concept, other technical solutions formed by any combination of the above technical features or their equivalent features. For example, a technical solution formed by replacing the above features with technical features with similar functions disclosed in the present disclosure (but not limited thereto) also falls within the protection scope of the present disclosure.

In addition, although the various operations are depicted in a particular order, this should not be understood as requiring the operations to be performed in the particular order shown or in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are only example forms for implementing the claims. Regarding the apparatus in the above embodiments, the specific manner in which each module performs an operation has been described in detail in the embodiments relating to the method, and will not be detailed herein.

I/We claim:

1. An information display method, comprising:
displaying an object management page for managing a target object; and
in response to a trigger operation on association information of the target object in the object management page, displaying target association information of the target object, wherein the target association information is used for representing an association cognition of a user to the target object, the target association information comprises first association information and/or second association information, the first association information is used for representing association cognition information of the user to a category to which the target object belongs and the target object, and the second association information is used for representing association cognition information of the user to an attribute word of the target object and the target object.

2. The information display method of claim 1, wherein the first association information comprises indicator information corresponding to a first indicator and/or indicator information corresponding to a second indicator, the first indicator is used for representing an association probability of the user to the category to which the target object belongs and the target object, and the second indicator is used for representing an interaction indicator of the user for the target object in the category to which the target object belongs.

3. The information display method of claim 1, wherein displaying the target association information of the target object comprises:
displaying a first page option for triggering to display the second association information, wherein the first page option comprises at least one of a first option, a second option, or a third option, the first option is used for triggering to display a preset number of attribute words of the target object that satisfy a first preset condition, the second option is used for triggering to display a custom attribute word of the target object, and the third option is used for triggering to display a product function attribute word of the target object; and
in response to a trigger operation on a first target option in the first page option, displaying target indicator information and a target attribute word corresponding to the first target option, the target indicator information being used for measuring an association cognition degree of the user to the target attribute word and the target object.

4. The information display method of claim 3, wherein in response to the trigger operation on the first target option in the first page option, displaying the target indicator information and the target attribute word corresponding to the first target option comprises:
in response to the trigger operation on the first target option in the first page option, displaying the target attribute word corresponding to the first target option; and
in response to a trigger operation on the target attribute word, displaying the target indicator information.

5. The information display method of claim 3, further comprising:
in response to a trigger operation on the target attribute word, displaying a change trend of the target indicator information with time, and/or, displaying ranking information of the target object in the category to which the target object belongs based on the target indicator information.

6. The information display method of claim 3, further comprising:
associatively displaying a first control with the target attribute word, wherein the first control is at least used for triggering to display association cognition details of the user to the target attribute word and the target object; and
in response to a trigger operation on the first control, displaying a first detail page, and displaying the association cognition details of the user to the target attribute word and the target object on the first detail page.

7. The information display method of claim 6, further comprising:
displaying a second page option on the first detail page, wherein the second page option is used for triggering to display comparison information between different objects in the category to which the target object belongs based on a comparison dimension, the different objects comprise the target object, and the comparison dimension comprises an indicator dimension obtained based on the target indicator information;
in response to a trigger operation on the second page option, displaying a first configuration control for configuring the comparison dimension; and
in response to a first configuration operation on the comparison dimension in the first configuration control, displaying the comparison information between the different objects according to the comparison dimension corresponding to the first configuration operation.

8. The information display method of claim 6, further comprising:
displaying a third page option on the first detail page, wherein the third page option is used for triggering to display multimedia content related to the target object; and
in response to a trigger operation on the third page option, displaying a multimedia content list, wherein the multimedia content list comprises a first list and a second list, the first list is used for displaying multimedia content for which association cognition information of the user to the target object satisfies a second preset condition and/or play information of the target object satisfies a third preset condition, and the second list is used for displaying multimedia content for which the association cognition information of the user to the target object does not satisfy the second preset condition and/or the play information of the target object does not satisfy the third preset condition.

9. The information display method of claim 6, further comprising:
displaying a fourth page option on the first detail page, the fourth page option being used for triggering to display delivery channel information of the target object; and
in response to a trigger operation on target delivery channel information in the delivery channel information, displaying a change trend of an association degree of the user to the target object with time under a delivery channel corresponding to the target delivery channel information.

10. The information display method of claim 3, wherein displaying the target attribute word corresponding to the first target option and the target indicator information comprises:
displaying the target attribute word corresponding to the first target option and the target indicator information in a first display style; and
in response to a switch operation on the display style, determining a second display style corresponding to the switch operation, and displaying the target attribute word corresponding to the first target option and the target indicator information in the second display style, wherein the second display style is different from the first display style.

11. The information display method of claim 3, wherein the custom attribute word of the target object is obtained by:
displaying a second configuration control, the second configuration control being used for adding the custom attribute word for the target object; and
in response to a configuration operation through the second configuration control, determining a first attribute word to be added and/or a second attribute word to be excluded, and determining the custom attribute word of the target object according to the first attribute word and/or the second attribute word.

12. The information display method of claim 1, further comprising:
displaying a second control, the second control being used for triggering to display ranking information of the target object in the category to which the target object belongs based on the first association information;
in response to a trigger operation on the second control, displaying a second detail page, and displaying ranking information of the target object under a third indicator comprised in the first association information in the second detail page; and
in response to a selection operation for a fourth indicator comprised in the first association information in the second detail page, switching and displaying the ranking information displayed in the second detail page to ranking information of the target object under the fourth indicator.

13. The information display method of claim 12, further comprising:
in response to a trigger operation on ranking information corresponding to the target object in the ranking information, displaying data detail information of the target object under the fourth indicator, the data detail information comprising indicator information corresponding to a plurality of disassembly indicators obtained by disassembling the fourth indicator; and
in response to a trigger operation on target indicator information in the data detail information, displaying multimedia content, wherein the target indicator information is obtained based on the multimedia content.

14. The information display method of claim 1, further comprising:
displaying a third control in the object management page, the third control being used for triggering to display attribute word information for the target object, the attribute word information comprising first attribute word information, and the first attribute word information being used for indicating information of an attribute word that needs attention in the target object; and
in response to a trigger operation on the third control in the object management page, displaying the attribute word information for the target object.

15. The information display method of claim 14, wherein the attribute word information further comprises second attribute word information, and the second attribute word information is used for indicating at least one of:
information of a preset number of attribute words of the target object that satisfy a fourth preset condition;
information of the preset number of attribute words that satisfy the fourth preset condition in other objects than the target object in the category to which the target object belongs; and
information of the preset number of attribute words that satisfy the fourth preset condition in the category to which the target object belongs.

16. An electronic device, comprising:
a storage having a computer program stored thereon; and
a processor configured to execute the computer program in the storage to cause the electronic device to:
display an object management page for managing a target object; and
in response to a trigger operation on association information of the target object in the object management page, display target association information of the target object, wherein the target association information is used for representing an association cognition of a user to the target object, the target association information comprises first association information and/or second association information, the first association information is used for representing association cognition information of the user to a category to which the target object belongs and the target object, and the second association information is used for representing association cognition information of the user to an attribute word of the target object and the target object.

17. The electronic device of claim 16, wherein the first association information comprises indicator information corresponding to a first indicator and/or indicator information corresponding to a second indicator, the first indicator is used for representing an association probability of the user to the category to which the target object belongs and the target object, and the second indicator is used for representing an interaction indicator of the user for the target object in the category to which the target object belongs.

18. The electronic device of claim 16, wherein the target association information is displayed by:
displaying a first page option for triggering to display the second association information, wherein the first page option comprises at least one of a first option, a second option, or a third option, the first option is used for triggering to display a preset number of attribute words of the target object that satisfy a first preset condition, the second option is used for triggering to display a custom attribute word of the target object, and the third option is used for triggering to display a product function attribute word of the target object; and
in response to a trigger operation on a first target option in the first page option, displaying target indicator information and a target attribute word corresponding to the first target option, the target indicator information being used for measuring an association cognition degree of the user to the target attribute word and the target object.

19. The electronic device of claim 16, wherein the electronic device is further caused to:
display a second control, the second control being used for triggering to display ranking information of the target object in the category to which the target object belongs based on the first association information;
in response to a trigger operation on the second control, display a second detail page, and displaying ranking information of the target object under a third indicator comprised in the first association information in the second detail page; and
in response to a selection operation for a fourth indicator comprised in the first association information in the second detail page, switch and displaying the ranking information displayed in the second detail page to ranking information of the target object under the fourth indicator.

20. A non-transitory computer-readable storage medium having stored thereon a computer program that, when executed by a processor, implements a method comprising:
displaying an object management page for managing a target object; and
in response to a trigger operation on association information of the target object in the object management page, displaying target association information of the target object, wherein the target association information is used for representing an association cognition of a user to the target object, the target association information comprises first association information and/or second association information, the first association information is used for representing association cognition information of the user to a category to which the target object belongs and the target object, and the second association information is used for representing association cognition information of the user to an attribute word of the target object and the target object.
